(19) United States
(12) Patent Application Publication
(10) Pub. No.: US 2017/0299060 A1
(43) Pub. Date: Oct. 19, 2017

(54) PACKING GLAND FOLLOWER

(71) Applicant: Sound Seal & Packing Co., Edmonds, WA (US)

(72) Inventors: Ward Forrest, Edmonds, WA (US); Edmund Tonkin, Edmonds, WA (US)

(21) Appl. No.: 15/097,980

(22) Filed: Apr. 13, 2016

(51) Int. Cl. F16J 15/18; F16J 15/24

(52) U.S. Cl. CPC F16J 15/184; F16J 15/24

(57) ABSTRACT

An apparatus for restricting flow of a fluid along a shaft passing through the apparatus while permitting the shaft to freely rotate can include a housing, a gland follower, a fastening mechanism, and a biasing mechanism. The gland follower may include a center aperture for receiving the shaft and at least one fastening aperture. When installed, the fastening mechanism mechanically couples the gland follower to the housing to define a cavity in conjunction with a recess within the housing. Also, the biasing mechanism generates a predetermined force when installed that biases the gland follower towards the housing in a direction parallel to an axis of rotation of the shaft. The predetermined force can be translated into a force that deforms packing material inserted into the cavity to provide sealing engagement with the shaft.

### BACKGROUND

The present invention relates broadly to an apparatus for restricting flow of a fluid along a rotatable shaft while permitting the shaft to rotate about an axis of rotation. Conventional solutions of restricting the flow of a fluid along a rotatable shaft, such as stuffing boxes, tend to become less effective over time during normal operation of the rotatable shaft. One such conventional solution includes enclosing a portion of the rotatable shaft with a stuffing box. Packing material is inserted into the stuffing box and deformed by manually adjusting the stuffing box to compress the packing material. The deformed packing material provides sealing engagement with the rotatable shaft, thereby restricting flow of a fluid along the rotatable shaft. The sealing engagement with the rotatable shaft diminishes during normal operation for various reasons. For example, frictional forces at the interface between the packing material and rotatable shaft may result in erosion of the packing material. The sealing engagement with the rotatable shaft may be improved by manually adjusting the stuffing box to further compress the packing material. While manual adjustment of the stuffing box may restrict fluid around the rotatable shaft, it is also labor intensive. Moreover, conventional solutions tend to utilize skilled labor for such manual adjustments in order to meet particular operational specifications, thereby further increasing labor costs.

### BRIEF DESCRIPTION OF THE DRAWINGS

Throughout the drawings, reference numbers may be re-used to indicate correspondence between referenced elements. The drawings are provided to illustrate example embodiments described herein and are not intended to limit the scope of the disclosure.

FIG. 1 depicts a partial cross-sectional view of centrifugal pump as an example of a device having a rotatable shaft in which embodiments of the invention may be implemented.

FIG. 2 depicts an embodiment of an enlarged cross-sectional view of a mechanical seal of the centrifugal pump depicted in FIG. 1.

FIG. 3 is a top plan view of a gland follower in accordance with an embodiment of the present invention.

FIG. 4 is a cross-sectional side view of the gland follower depicted by FIG. 3 taken from the perspective of line 4-4 in FIG. 3.

FIG. 5 is a top plan view of a gland follower in accordance with an embodiment of the present invention.

FIG. 6 is an exploded top plan view of the gland follower depicted by FIG. 5.

FIG. 7 is a cross-sectional side view of the gland follower depicted by FIG. 5 taken from the perspective of line 7-7 in FIG. 7.

### DETAILED DESCRIPTION OF ILLUSTRATIVE EMBODIMENTS

Directional terms such as “outer”, “inner”, “forward”, “rearward”, “upwards”, “downwards”, “vertically”, “inward”, “outward”, and “radially” are used in the following description for the purpose of providing relative reference only, and are not intended to suggest any limitations on how any article is to be positioned during use, or to be mounted in an assembly or relative to an environment. Additionally, the term “couple” and variants of it such as “coupled”, “couples”, and “coupling” as used in this description are intended to include indirect and direct mechanical connections unless otherwise indicated. For example, if a first object is coupled to a second object, that coupling may be through a direct mechanical connection or through an indirect mechanical connection via other intervening objects, such as via gaskets and spacers.

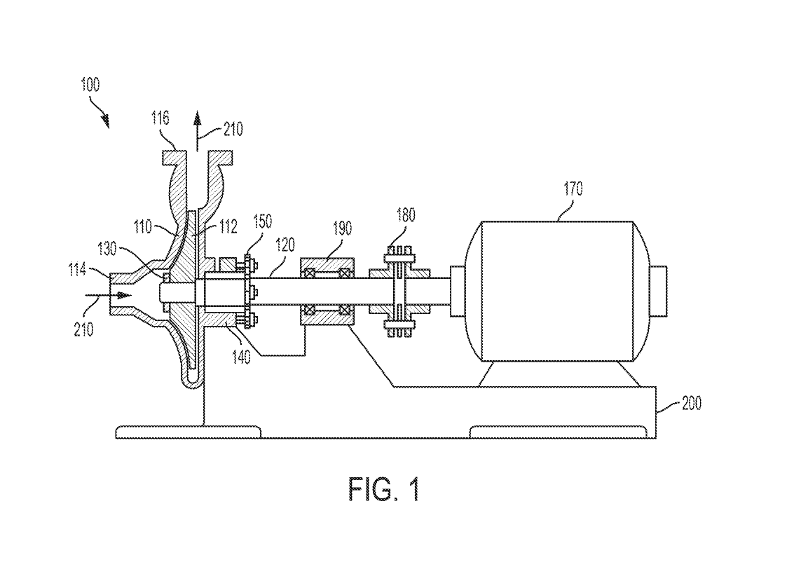

FIG. 1 depicts a partial cross-sectional view of centrifugal pump 100, as an example of a mechanical device with a rotatable shaft. However, it should be understood that centrifugal pump 100 is provided to illustrate aspects of the present invention for the purposes to enablement. Embodiments of the present invention are equally applicable to any type of mechanical device having a rotatable shaft without departing from the spirit of the disclosed invention. By way of example, embodiments of the present invention may be coupled to a propeller shaft for nautical applications or implemented in any type of rotating equipment such as pumps, turbines, compressors, gear boxes, and engines. Therefore, centrifugal pump 100 is not intended to suggest any limitation as to the scope, use, or functionality of the present invention. Neither should centrifugal pump 100 be interpreted as having any dependency or requirement relating to any one or combination of components illustrated in the following embodiments.

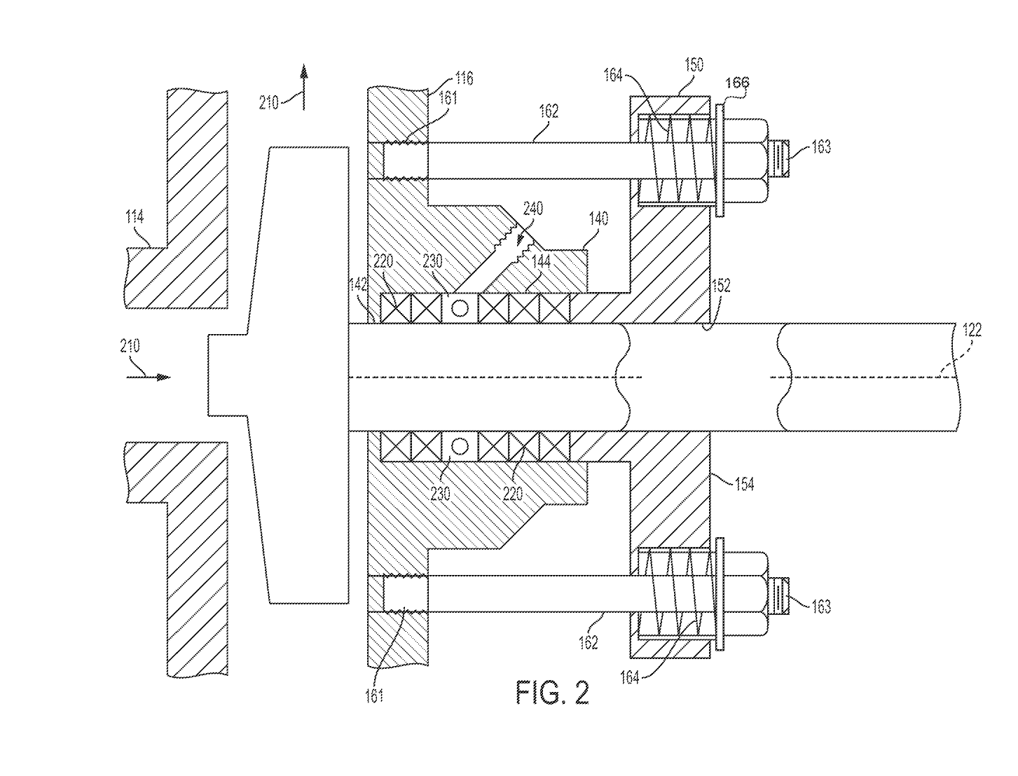

As shown in the example depicted by FIG. 1, centrifugal pump 100 is mounted on frame 200 and includes pump casing 110. Enclosed within pump casing 110 is impeller 112 which is coupled to rotatable shaft 120 with fastener 130. In an embodiment, centrifugal pump 100 may be a multi-stage centrifugal pump, and consequently include more than one impeller. Rotatable shaft 120 passes through shaft aperture 142 into a recess defined by an interior surface 144 of housing 140 that is mechanically coupled to pump casing 110, as shown in greater detail by FIG. 2. One skilled in the art will recognize that housing 140 may be referred to as a stuffing box in the depicted embodiment. At an end of housing 140 opposing shaft aperture 142, housing 140 is mechanically coupled to gland follower 150.

As best seen in FIG. 2, gland follower 150 defines a cavity in conjunction with the recess defined by the interior surface 144 of housing 140. Gland follower 150 may be mechanically coupled to housing 140 using at least one fastening mechanism 162 disposed within a corresponding fastening aperture (not shown). In an embodiment, fastening mechanism 162 is a bolt that mechanically couples gland follower 150 to housing 140 by engaging with housing 140 via at least one fastening aperture. In an embodiment, at least one washer (e.g. washer 165) is used in conjunction with fastening mechanism 162 to mechanically couple gland follower 150 to housing 140. In an embodiment, a nut (e.g. nut 166) is used in conjunction with fastening mechanism 162 to mechanically couple gland follower 150 to housing 140. In an embodiment, fastening mechanism 162 includes a distal end 161 and a proximal end 163 that mechanically couples gland follower 150 to housing 140 by engaging with housing 140 with the proximal end via at least one fastening aperture. In an embodiment, any known means of coupling two or more objects may be used to implement fastening mechanism 162 including hardware means (e.g. screws, clamps, and the like), fusion-based coupling means (e.g. welding, brazing, and the like), and force-based coupling means (e.g. vacuum, magnets, and the like). Rotatable shaft 120 passes through housing 140 by exiting the cavity via center aperture 152 of gland follower 150. Alternatively, if tracing rotatable shaft 120 in an opposite direction towards impeller 112, rotatable shaft 120 enters the cavity via center aperture 152 from an outer surface 154 of gland follower 150.

As shown in FIG. 1, upon exiting the cavity, rotatable shaft 120 is coupled to a pump driver 170 that provides a rotary force (or torque) when operational to centrifugal pump 100 via rotatable shaft 120. In an embodiment, pump driver 170 may include one or more of an electric motor, a steam turbine, an expansion turbine, a gas turbine, and an internal combustion engine. In an embodiment, a transmission (e.g. transmission 180) may intervene between pump driver 170 and rotatable shaft 120. In an embodiment, rotatable shaft 120 may pass through a bearing housing (e.g. bearing housing 190) between centrifugal pump 100 and pump driver 170 to provide rotatable shaft 120 with additional support.

Turning to FIG. 2, the rotary force provided by pump driver 170 is applied to rotatable shaft 120 when operational. In response to the applied rotary force, rotatable shaft 120 rotates about an axis of rotation defined by a central longitudinal axis 122 of rotatable shaft 120. By rotating about its axis of rotation, rotatable shaft 120 transfers the rotary force provided by pump driver 170 to centrifugal pump 100. Impeller 112 of centrifugal pump 100 receives the rotary force and, in response, rotates within pump casing 110. The rotation of impeller 112 creates a pressure differential between suction port 114 and discharge port 116. As a result of the pressure differential, fluid enters centrifugal pump 100 via suction port 114 and exits via discharge port 116 (the resulting fluid flow referenced generally by directional arrow 210).

This operation may be facilitated by providing slight gaps around rotatable shaft 120 as it passes through other mechanical components, thereby enabling rotatable shaft 120 to freely rotate. For example, slight gaps may exist between rotatable shaft 120 and shaft aperture 142 (or center aperture 152). As known by those skilled in the art, the slight gaps provided to enable rotatable shaft 120 to freely rotate will also provide a route for the fluid being pumped to leak. One means to prevent such leakage while enabling rotatable shaft 120 to freely rotate is to insert packing material 220 into the cavity formed by gland follower 150 in conjunction with the recess within housing 140.

Non-limiting examples of suitable packing materials are taught in U.S. Pat. No. 3,646,846 to Houghton, et al. on Mar. 7, 1972; U.S. Pat. No. 5,225,262 to Leduc issued on Jul. 6, 1993; U.S. Pat. No. 6,385,956 to Ottinger, et al. on May 14, 2002; U.S. Pat. No. 6,644,007 to Fujiwara et al. on Nov. 11, 2003; and U.S. Pat. No. 6,502,382 to Fujiwara et al. on Jan. 7, 2003. As known, conventional packings can be fabricated by forming synthetic fibers (e.g. polytetrafluoroethylene) or non-synthetic (e.g. flax and jute) fibers into yarns or strands, which are braided together about core strands. The result is typically a packing having a square cross-section and herringbone weave pattern extending in an axial direction along the packing. As such, packing material 220 may need to be deformed to provide sealing engagement with rotatable shaft 120 to prevent leakage of the fluid being pump while enabling rotatable shaft 120 to freely rotate.

Deforming packing material 220 inserted into the cavity to provide such sealing engagement with rotatable shaft 120 may be achieved by exerting a compressive force on packing material 220 in a direction parallel to the rotatable shaft's axis of rotation. Since packing material 220 inserted into the cavity is somewhat constrained (e.g. by way of interior surface 144 and the surface in which shaft aperture 142 is formed) packing material 220 may be pressed inward within the cavity by the compressive force. Such compressive force on the packing material may be exerted by translating gland follower 150 towards housing 140 in a direction parallel to the axis of rotation of rotatable shaft 120.

In accordance with embodiments of the present invention, compressive force exerted by gland follower 150 is generated by at least one biasing mechanism 164 disposed within the at least one fastening aperture. In an embodiment, biasing mechanism 164 is a spring having a spring rate sufficient to generate a predetermined force that biases gland follower 150 towards housing 140. In an embodiment, a predetermined force is based on a desired compressive force that is established for a particular packing material. In an embodiment, biasing mechanism 164 is a spring having a spring rate sufficient to generate a predetermined force at a predetermined extended length that biases gland follower 150 towards housing 140. In an embodiment, biasing mechanism 164 is mounted over fastening mechanism 162 within the at least one fastening aperture.

In an embodiment, centrifugal pump 100 can also include a lantern ring 230. Lantern ring 230 can be a flexible material having a substantially cylindrical outer surface with one or more outer ridges, a substantially cylindrical inner bore surface with one or more inner ridges, one or more through holes from at least an outer ridge to an inner ridge, a first annular end, and a second annular end. The through holes can allow for liquid, such as lubrication and/or cleaning liquid to pass from the outside of centrifugal pump 100 to rotatable shaft 120.

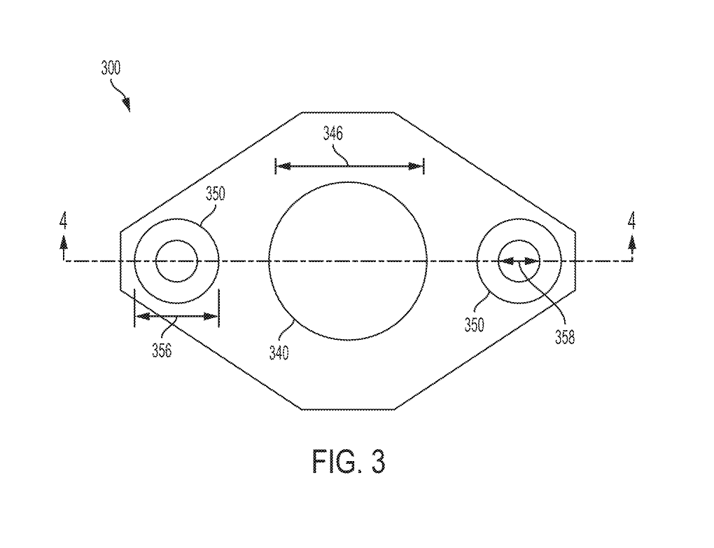

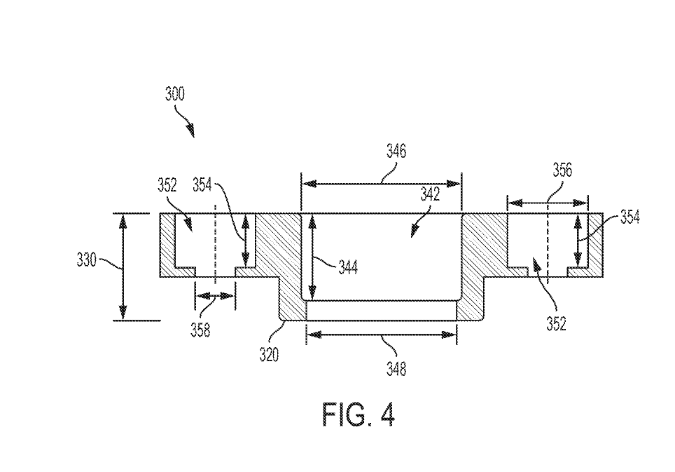

FIGS. 3 and 4 depict an embodiment of a gland follower, which is generally referred to as gland follower 300. More specifically, FIG. 3 depicts a top plan view of gland follower 300, and FIG. 4 depicts a cross-sectional side view of gland follower 300 taken from the perspective of line 4-4 in FIG. 3. Gland follower 300 can be made of any rigid material that will allow gland follower 300 to exert a compressive force on packing material while being subjected to operating conditions (e.g. temperature, durability, chemical properties of a fluid being pumped, and the like) corresponding to the rotatable shaft. For example, gland follower 300 may be made from stainless steel, brass, cast iron, and the like.

As shown by FIG. 4, gland follower 300 includes an outer surface 310 facing away from a housing (e.g. housing 140 of FIG. 2) and an inner surface 320 facing towards the housing when installed. As used herein, a “profile” of gland follower 300 is defined by thickness 330 that represents a distance in a direction parallel to an axis of rotation of a rotatable shaft (e.g. rotatable shaft 120 of FIG. 1) between outer surface 310 and inner surface 320.

Gland follower 300 also includes center aperture 340 that is substantially aligned with a central longitudinal axis (e.g. central longitudinal axis 122 of FIG. 1) the rotatable shaft. Center aperture 340 may be a passage extending through gland follower 300 having a diameter 348 in a region proximate a cavity formed in conjunction with a recess of a housing. In an embodiment, center aperture 340 may include an opening 342 that extends partially through gland follower 300 from outer surface 310 to a depth 344, as depicted in the example illustrated by FIGS. 3 and 4. In an embodiment, opening 342 includes a diameter 346 in a region proximate outer surface 310. In an embodiment, diameter 346 may be different than diameter 348. In an embodiment, one or more of diameter 346 and diameter 348 may be determined based on an outer diameter of the rotatable shaft.

Gland follower 300 includes at least one fastening aperture 350 for accommodating at least one fastening mechanism and at least one biasing mechanism (e.g. fastening mechanism 162 and biasing mechanism 164 of FIG. 2, respectively). In an embodiment, gland follower 300 may include more than one fastening aperture, as depicted in the example of FIGS. 3 and 4. For example, gland follower 300 may include fastening apertures on opposing sides of center aperture 340 in radially outward directions relative to center aperture 340. As best illustrated in FIG. 4, fastening aperture 350 includes opening 352 that extends partially through gland follower 300 from outer surface 310 to a depth 354. In an embodiment, depth 354 is selected based on an extended length of a biasing mechanism disposed within fastening aperture 350.

Diameter 356 of opening 352 may be selected based on various design constraints. In an embodiment, diameter 356 is selected such that diameter 356 exceeds an outer diameter of a biasing mechanism disposed within fastening aperture 350. In an embodiment, diameter 356 is selected such that diameter 356 exceeds an outer diameter of a distal end of a fastening mechanism disposed within fastening aperture 350. In an embodiment, a washer may be mounted inward of outer surface 310 on a fastening mechanism having an outer diameter at a distal end that does not exceed diameter 356. In an embodiment, diameter 356 is selected such that an outer diameter of a washer exceeds diameter 356. In an embodiment, diameter 356 is selected such that an outer diameter of a fastening mechanism disposed within fastening aperture 350 exceeds diameter 356.

Likewise, diameter 358 of fastening aperture 350 in a region proximate a cavity formed in conjunction with a recess of a housing may be selected based on various design constraints. In an embodiment, diameter 356 of opening 352 may be different than diameter 358. In an embodiment, diameter 356 of opening 352 is selected such that diameter 356 exceeds diameter 358. In an embodiment, diameter 358 is selected such that an outer diameter of a biasing mechanism disposed within fastening aperture 350 exceeds diameter 358. In an embodiment, diameter 358 is selected such that diameter 358 exceeds an outer diameter of a proximal end of a fastening mechanism disposed within fastening aperture 350.

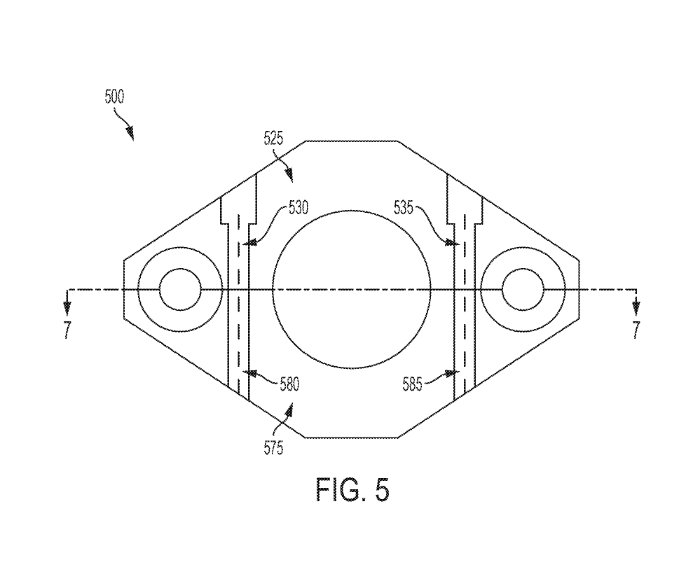

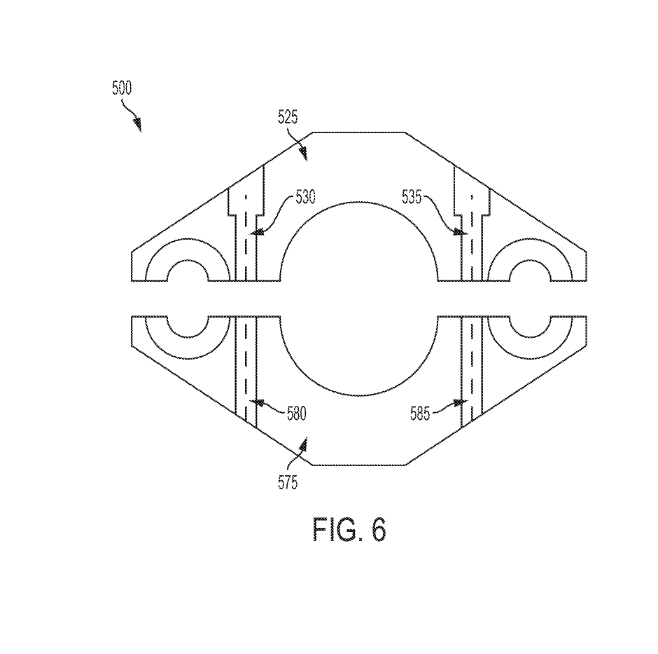

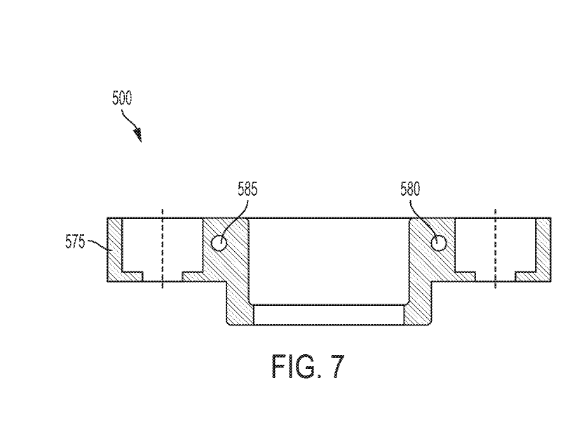

FIGS. 5-7 depict an embodiment of a gland follower, which is generally referred to as gland follower 500. More specifically, FIG. 5 depicts a top plan view of gland follower 500, FIG. 6 depicts an exploded top plan view of gland follower 500, and FIG. 7 depicts a cross-sectional side view of gland follower 500 taken from the perspective of line 7-7 in FIG. 5. In an embodiment, gland follower 500 is substantially similar to gland follower 300 unless indicated otherwise. As best illustrated in FIG. 6, gland follower 500 may be composed of multiple sections (e.g. section 525 and section 575) that collectively compose gland follower 500. In the embodiment depicted by FIGS. 5 and 6, gland follower 500 is composed of two sections. However, in other embodiments, a gland follower may be composed of three or more sections that collectively compose the gland follower.

Retention mechanisms may be utilized to mechanically couple two or more sections of a gland follower composed of multiple sections. In an embodiment, a retention mechanism inserted into a retention aperture disposed within a profile of a gland follower composed of multiple sections is used to mechanically couple two or more of the multiple sections. For example, gland follower 500 includes two retention apertures: a first retention aperture collectively composed of aperture 530 and aperture 580, and a second retention aperture collectively composed of aperture 535 and aperture 585. In this example, section 525 and section 575 may be mechanically coupled within a profile of gland follower 500 by inserting retention mechanisms (not shown) into one or more of the first retention aperture and the second retention aperture. In an embodiment, any known means of coupling two or more objects may be used to implement a retention mechanism including hardware means (e.g. screws, clamps, and the like), fusion-based coupling means (e.g. welding, brazing, and the like), and force-based coupling means (e.g. vacuum, magnets, and the like).

One of the benefits of a gland follower composed of multiple sections, such as gland follower 500, is ease of removing and/or replacing the gland follower when needed. As an example, gland follower 500 may be mechanically coupled to a device having a rotatable shaft like centrifugal pump 100 of FIG. 1. In this example, section 525 and section 575 may each be independently removed from the device upon removing any retention mechanisms present in the first retention aperture or second retention aperture. Upon removal any retention mechanisms used to mechanically couple section 525 and section 575, either section may be independently removed without removing additional components.

While the preferred embodiment of the invention has been illustrated and described, as noted above, many changes can be made without departing from the spirit and scope of the invention. For example, neither dimensions of a fastening mechanism diameter relative to a fastening aperture diameter nor the number of sections collectively composing a gland follower is critical and may be adjusted in accord with the particular application.

The various features and processes described above may be used independently of one another, or may be combined in various ways. All possible combinations and sub-combinations are intended to fall within the scope of this disclosure. In addition, certain method or process blocks may be omitted in some implementations. The methods and processes described herein are also not limited to any particular sequence, and the blocks or states relating thereto can be performed in other sequences that are appropriate. For example, described blocks or states may be performed in an order other than that specifically disclosed, or multiple blocks or states may be combined in a single block or state. The example blocks or states may be performed in serial, in parallel or in some other manner. Blocks or states may be added to or removed from the disclosed example embodiments. The example systems and components described herein may be configured differently than described. For example, elements may be added to, removed from or rearranged compared to the disclosed example embodiments.

Conditional language used herein, such as, among others, “can,” “could,” “might,” “may,” “e.g.,” and the like, unless specifically stated otherwise, or otherwise understood within the context as used, is generally intended to convey that certain embodiments include, while other embodiments do not include, certain features, elements and/or steps. Thus, such conditional language is not generally intended to imply that features, elements and/or steps are in any way required for one or more embodiments or that one or more embodiments necessarily include logic for deciding, with or without author input or prompting, whether these features, elements and/or steps are included or are to be performed in any particular embodiment. The terms “comprising,” “including,” “having,” and the like are synonymous and are used inclusively, in an open-ended fashion, and do not exclude additional elements, features, acts, operations and so forth. Also, the term “or” is used in its inclusive sense (and not in its exclusive sense) so that when used, for example, to connect a list of elements, the term “or” means one, some or all of the elements in the list.

While certain example embodiments have been described, these embodiments have been presented by way of example only, and are not intended to limit the scope of the inventions disclosed herein. Thus, nothing in the foregoing description is intended to imply that any particular feature, characteristic, step, module or block is necessary or indispensable. Indeed, the novel methods and systems described herein may be embodied in a variety of other forms; furthermore, various omissions, substitutions and changes in the form of the methods and systems described herein may be made without departing from the spirit of the inventions disclosed herein. The accompanying claims and their equivalents are intended to cover such forms or modifications as would fall within the scope and spirit of certain of the inventions disclosed herein.

1. A gland follower configured to define a cavity in conjunction with a recess within a housing when coupled to the housing, the gland follower comprising:
a center aperture configured to receive a shaft entering the recess from an outer surface of the gland follower, the outer surface being external to the cavity and orthogonal to an axis of rotation of the shaft that is disposed along a centerline of the shaft;
at least one fastening aperture having an opening that extends partially through the gland follower;
a fastening mechanism disposed within the at least one fastening aperture and configured to mechanically couple the gland follower to the housing such that one end of the gland follower contacts a floor within the cavity, and an opposite end contacts a fastening member on the fastening mechanism;
a biasing mechanism disposed within the at least one fastening aperture and configured to generate a predetermined force that when installed biases the gland follower towards the housing in a direction parallel to the axis of rotation, the predetermined force translated into a force that deforms packing material within the cavity to provide sealing engagement with the shaft; and
wherein a plurality of sections collectively compose the gland follower along a radial direction of the biasing mechanism.

2. The gland follower of claim 1, wherein the biasing mechanism is a spring having a spring rate sufficient to generate the predetermined force that is mounted over the fastening mechanism within the at least one fastening aperture.

3. The gland follower of claim 1, wherein each section of the plurality of sections is removable from the remaining sections of the plurality of sections while the gland follower is coupled to the housing.

4. The gland follower of claim 3, wherein at least one retention mechanism disposed within a profile of the gland follower is configured to mechanically couple at least two sections of the plurality of sections.

5. The gland follower of claim 1, wherein the fastening mechanism is a bolt configured to mechanically couple the gland follower to the housing by engaging with the housing via the at least one fastening mechanism.

6. The gland follower of claim 1, wherein the opening comprises a first diameter that exceeds an outer diameter of the biasing mechanism, and wherein the at least one fastening aperture comprises a second diameter in a region proximate the cavity that exceeds an outer diameter of the fastening mechanism.

7. An apparatus for restricting flow of a fluid along a shaft passing through the apparatus while permitting the shaft to freely rotate, the apparatus comprising:
a housing having an interior surface defining a recess within the housing;
a gland follower comprising a center aperture and at least one fastening aperture, the gland follower defining a cavity in conjunction with the recess, wherein the center aperture configured to receive the shaft entering the cavity from an outer surface of the gland follower that is orthogonal to an axis of rotation of the shaft that is disposed along a centerline of the shaft;
a fastening mechanism disposed within the at least one fastening aperture that when installed mechanically couples the gland follower to the housing such that one end of the gland follower contacts a floor within the cavity, and an opposite end contacts a fastening member on the fastening mechanism;
a biasing mechanism disposed within the at least one fastening aperture that when installed generates a predetermined force that biases the gland follower towards the housing in a direction parallel to the axis of rotation, the predetermined force translated into a force that deforms packing material within the cavity to provide sealing engagement with the shaft; and
wherein a plurality of sections collectively compose the gland follower along a radial direction of the biasing mechanism.

8. The apparatus of claim 7, wherein the at least one fastening aperture includes an opening having a depth that extends partially through the gland follower from the outer surface in the direction parallel to the axis of rotation.

9. The apparatus of claim 8, wherein the depth is less than a thickness of the gland follower but large enough to accommodate the biasing mechanism within a profile of the gland follower.

10. The apparatus of claim 8, wherein the biasing mechanism is a spring having a spring rate sufficient to generate the predetermined force at an extended length, and wherein the depth is based on the extended length.

11. The apparatus of claim 8, wherein the fastening mechanism is a bolt having a distal end and a proximal end configured to engage with the housing.

12. The apparatus of claim 11, wherein an outer diameter of the distal end exceeds a diameter of the opening.

13. The apparatus of claim 11, wherein an inner diameter of the at least one fastening aperture proximate the cavity exceeds an outer diameter of the proximal end.

14. The apparatus of claim 8, further comprising a washer mounted on the fastening mechanism and inward of the outer surface.

15. The apparatus of claim 14, wherein an inner diameter of the opening exceeds an outer diameter of the fastening mechanism.

16. The apparatus of claim 14, wherein an outer diameter of the washer exceeds an inner diameter of the opening.

17. The apparatus of claim 8, wherein the at least one fastening aperture includes a first fastening aperture and a second fastening aperture on opposing sides of the center aperture in radially outward directions relative to the center aperture.

18. A stuffing box for restricting flow of a fluid along a shaft passing through a cavity while permitting the shaft to freely rotate, the stuffing box comprising:
a housing comprising an interior surface defining a recess within the housing, a first end having a shaft aperture, and a second end opposing the first end in a direction parallel to an axis of rotation of the shaft that is disposed along a centerline of the shaft;
a gland follower comprising a center aperture and at least one fastening aperture having an opening, wherein the gland follower defines a cavity in conjunction with the recess, and wherein the center aperture configured to receive the shaft entering the cavity from an outer surface of the gland follower that is orthogonal to the axis of rotation of the shaft;
a fastening mechanism passing through the at least one fastening aperture that mechanically couples an inner surface of the gland follower opposing the outer surface to the second end of the housing such that one end of the gland follower contacts a floor within the cavity, and an opposite end contacts a fastening member on the fastening mechanism;
a biasing mechanism mounted on the fastening mechanism within the at least one fastening aperture that when installed generates a predetermined force that biases the gland follower towards the housing in the direction parallel to the axis of rotation, the predetermined force translated into a force that deforms packing material within the cavity to provide sealing engagement with the shaft; and
wherein a plurality of sections collectively compose the gland follower along a radial direction of the biasing mechanism.

19. The stuffing box of claim 18, wherein the at least one fastening aperture comprises a first diameter proximate the inner surface, wherein the opening comprises a second diameter, wherein an outer diameter of the fastening mechanism exceeds the first diameter; and wherein the second diameter exceeds an outer diameter of the biasing mechanism that exceeds the first diameter.

20. The stuffing box of claim 18, wherein the opening comprises a depth that exceeds a length of the biasing mechanism when operational.
